(19) United States
(12) Patent Application Publication
(10) Pub. No.: US 2016/0293148 A1
(43) Pub. Date: Oct. 6, 2016

(54) MUSIC INSTRUMENT CASE WITH INCORPROATED DETACHABLE STAND

(71) Applicant: Roger Potter, Surrey (CA)

(72) Inventor: Roger Potter, Surrey (CA)

(21) Appl. No.: 14/676,546

(22) Filed: Apr. 1, 2015

(51) Int. Cl. G10G 5/00

(52) U.S. Cl. CPC G10G 5/00

(57) ABSTRACT

The present invention provides an assembly for providing a detachable handle/stand that includes a main body, a top support dependent on the main body, at least three extendable and retractable members associated with the main body, a handle, and a mounting for selectively releasing and attaching said assembly to a musical instrument case.

### BACKGROUND OF THE INVENTION

All instruments require a Stand to place them on when not in use once out of their protective cases. No matter if it's a Pro Musician or simply a Hobby Musician, these instruments need a stand to rest upon, when not in use or waiting to be used. Not simply Guitars/Basses but even Wind instruments and so on. All instruments need cases and all instruments need stands.

Musicians typically have a plurality of cases and equipment that are transported to a performance site. All too often, a musician will arrive at a performance site and realize a piece of equipment has been forgotten. One piece of equipment that is continually used are stands that support either a musical instrument case or the musical instrument itself. The present invention addresses the need for providing stands that are incorporated into and onto the actual case.

### SUMMARY OF THE INVENTION

In one embodiment, the present invention is an assembly for providing a detachable handle/stand, said assembly comprising:

a main body;
a top support dependent on said main body;
at least three extendable and retractable members associated with said main body;
a handle;
a mounting for selectively releasing and attaching said assembly to a musical instrument case.

In one embodiment, the top support is adjustable in a length extending upward from said main body. That is to say, the top support is contemplated as being configured either at a fixed length, or an adjustable length incorporating an appropriate lock to lock the top support into a desired position extending upward from the main body.

In one embodiment, the top support has a standoff associated therewith. In one embodiment, the standoff is also provided in a fixed immovable position. In another embodiment, the standoff is provided as movable along the length of top support.

In one embodiment, the members are pivotably attached to said main body.

In one embodiment, the mounting includes a ball detent locking mechanism.

In one embodiment, the members include at least one member constructed and arranged for providing a base on which to stand a musical instrument case or musical instrument.

In one embodiment, the members further comprise motion restriction devices associated with hinges that provide for selectively extending a range of pivotable rotation. That is to say, the degree of rotation about the pivot is selectively adjustable and lockable.

### BRIEF DESCRIPTION OF THE SEVERAL VIEWS OF THE DRAWING

FIG. 1 is a partial cross section plan view of the system according to one embodiment of the present invention.

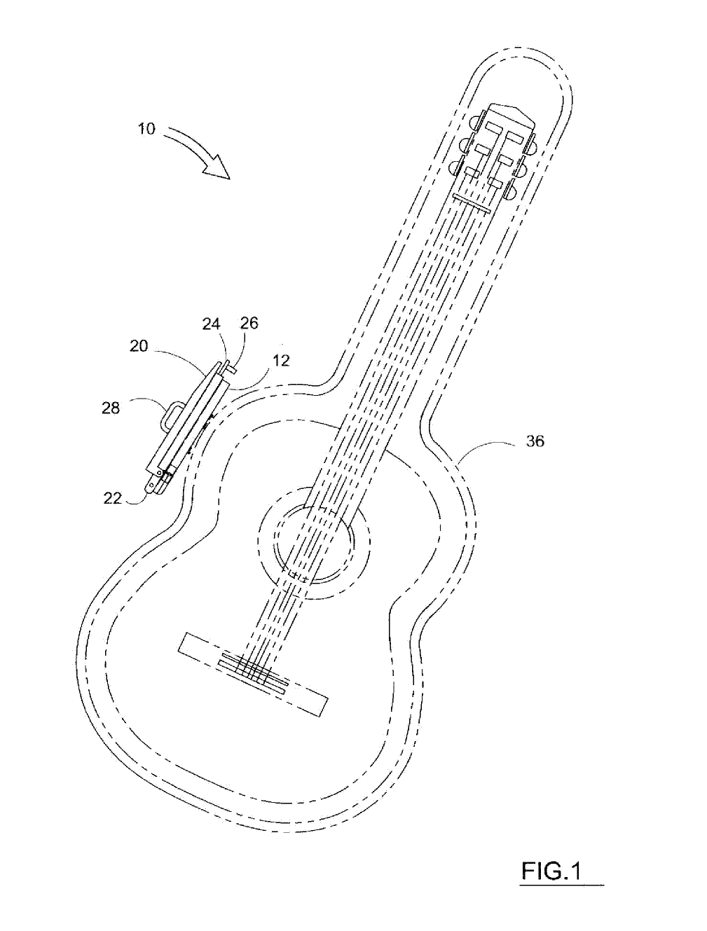

FIG. 2 is a side view demonstrating the detached stand and holding a case in an upright position according to one embodiment of the present invention.

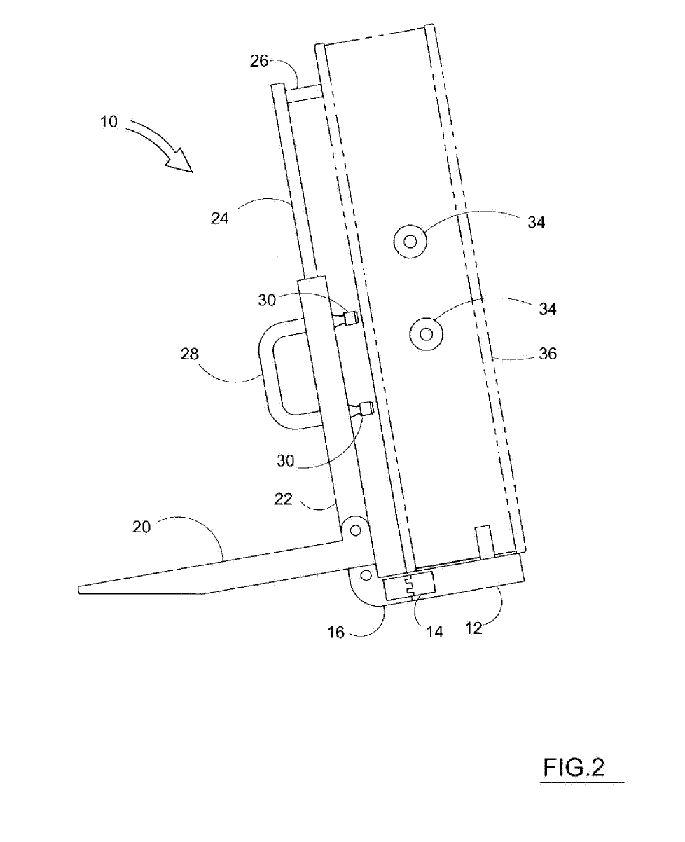

FIG. 3 is a side partial cross-section view demonstrating an attached stand and handle system attached to a case according to one embodiment of present invention.

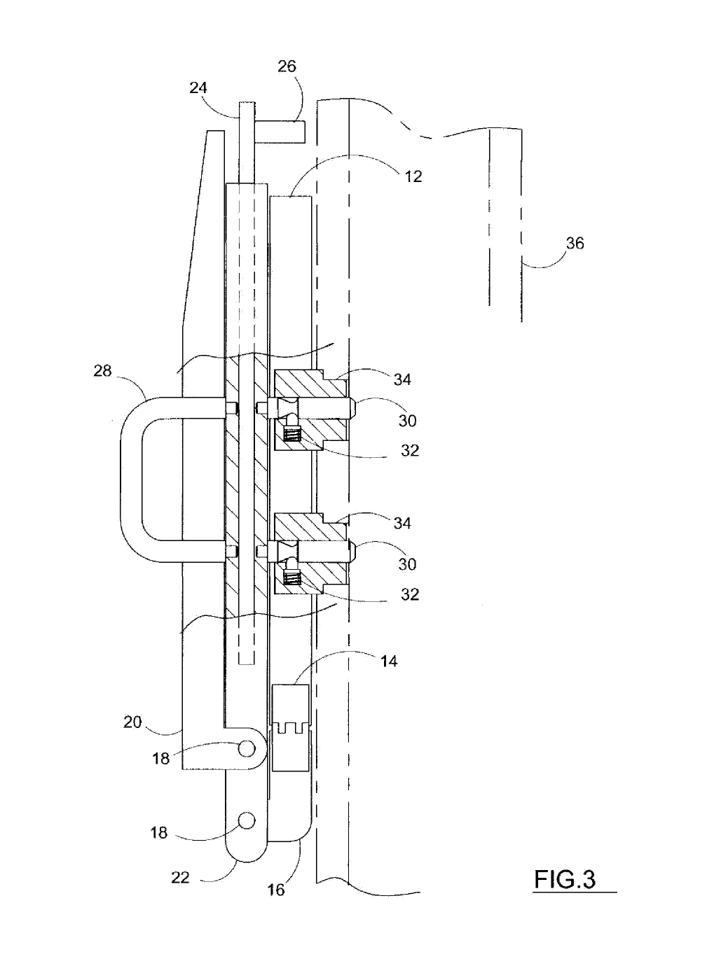

FIG. 4 is an exploded view of component parts according to one embodiment of the present invention.

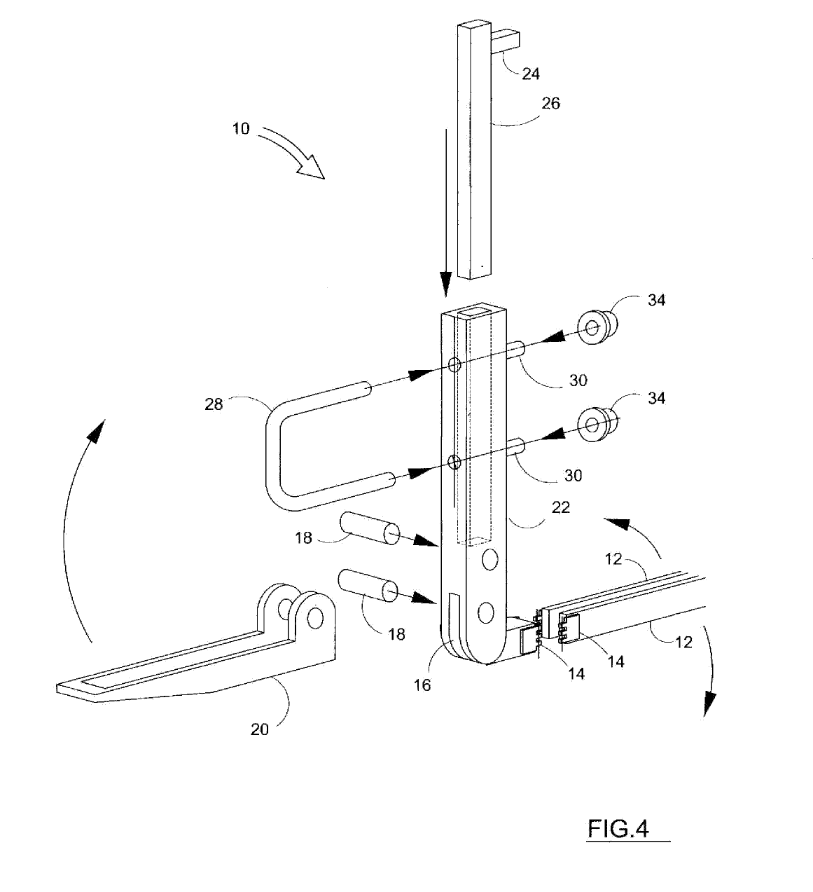

FIG. 5 is a side perspective view of the stand without the instrument case.

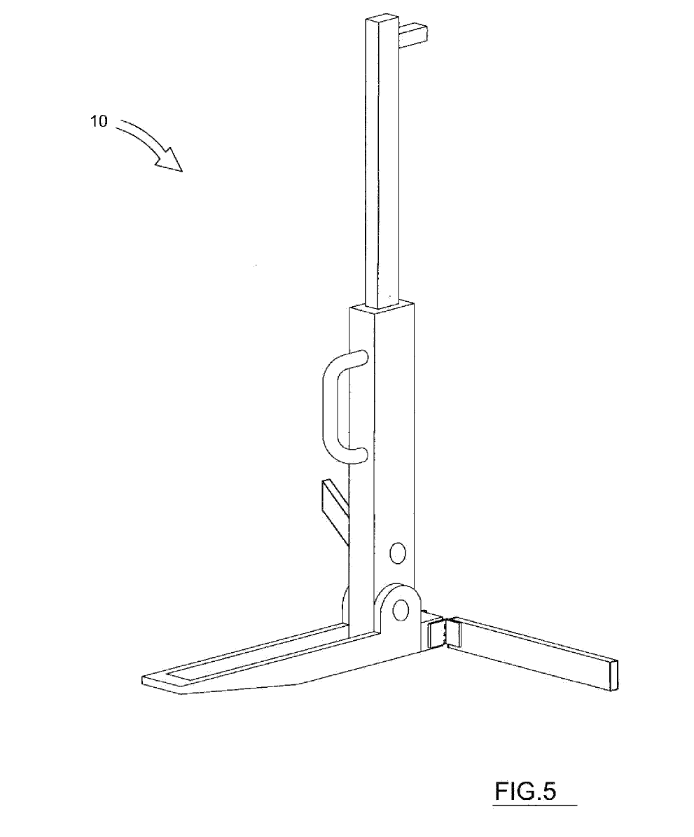

### DETAILED DESCRIPTION OF THE PREFERRED EMBODIMENT

The present invention is a system that provides a musical instrument case handle assembly that has a first folded configuration that is attached to a musical instrument case and a second unfolded configuration that detaches from a musical case and serves as an instrument or instrument case stand.

Assembly 10 is constructed and arranged with handle 28 and one or more connector pins 30 that connect into musical and shrimp case 36. In one embodiment, spring lock 32 is utilized in a ball detent locking system. Connector pin 30 connects into receiving insert 34 attached to case 36. Although the figures demonstrate a particular type of locking system, it is contemplated that any releasably attached system suitable for the intended purpose be utilized in the present invention.

The assembly includes rear leg 20 pivotably attached at pivot pin 18, top support 24 having incorporated there with top support standoff 26, and bottom leg 12 associated with bottom leg hinge 14. Vertical support 22 forms the main support body of system 10 and provide support for top support 24.

In the first or folded configuration connector pins 30 are connected and locked into position with receiving inserts 34. In the second or unfolded configuration assembly 10 is released from receiving inserts 34 on each of the rear leg 20 and bottom leg 12 are rotated to an extended position about their respective hinges to provide a stand configuration.

Although the particular embodiments of the figures demonstrate a music stand being held in the system of the present invention, it is further contemplated that the stand of the present invention be configured to hold a loose musical instrument with out the stand.

In one environment of use, a musician will attach the system to a musical instrument case and carry the case to a desired location. One typical desired location would be the site of a musical performance. The user will be able to carry case 36 using handle 28. Once arriving at the desired location, the user will detach the system of the present invention and configure each member, being the particular rear legs 20 and bottom leg 12 as desired to configure the system as a stand. As generally understood, pivots are provided such that the degree of pivotable rotation is selectively adjustable. In one embodiment, each pivotable rotation is selected based on a natural tension imparted based on assembly. A user will exert pressure against the tension to rotate each member a desired degree of rotation. The user will then either stand case 36 or an instrument (not shown) on the stand as desired.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. An assembly for providing a detachable handle/stand, said assembly comprising:
a main body;
a top support dependent on said main body;
at least three extendable and retractable members associated with said main body;
a handle;
a mounting for selectively releasing and attaching said assembly to a musical instrument case.

2. The assembly of claim 1 wherein said top support is adjustable in a length extending upward from said main body.

3. The assembly of claim 1 wherein said top support has a standoff associated therewith.

4. The assembly of claim 1 wherein said members are pivotably attached to said main body.

5. The assembly of claim 1 wherein said mounting includes a ball detent locking mechanism.

6. The assembly of claim 1 wherein said members include at least one member constructed and arranged for providing a base on which to stand a musical instrument case or musical instrument.

7. The assembly of claim 1 wherein said members further comprise motion restriction devices associated with hinges that provide for selectively extending a range of pivotable rotation.
